(19) United States
(12) Patent Application Publication
(10) Pub. No.: US 2011/0013875 A1
(43) Pub. Date: Jan. 20, 2011

(54) FIBER OPTIC ENCLOSURE WITH ADAPTER BULKHEAD POSITIONED BENEATH PIVOTAL SPLICE TRAY

(75) Inventors: Oscar Fernando Bran de León, Belle Plaine, MN (US); James J. Solheid, Lakeville, MN (US)

Correspondence Address: MERCHANT & GOULD PC, P.O. BOX 2903, MINNEAPOLIS, MN, 55402-0903, US

(73) Assignee: ADC Telecommunications, Inc., Eden Prairie, MN (US)

(21) Appl. No.: 12/838,133

(22) Filed: Jul. 16, 2010

Related U.S. Application Data
(60) Provisional application No. 61/226,273, filed on Jul. 16, 2009.

(51) Int. Cl. G02B 6/46

(52) U.S. Cl. 385/135

(57) ABSTRACT

A fiber optic enclosure includes an enclosure and a tray stack. The enclosure includes a base and a cover connected to the base. The base and the cover cooperate to define an interior region. The tray stack is disposed in the interior region of the enclosure. The tray stack includes a plurality of trays and a tray mounting plate. The tray mounting plate has a mounting portion and an adapter bulkhead portion. The mounting portion is adapted to receive the plurality of trays. The adapter bulkhead portion is adapted to receive a fiber optic adapter.

### CROSS-REFERENCE TO RELATED APPLICATIONS

The present application claims priority to U.S. Provisional Patent Application Ser. No. 61/226,273 entitled “Fiber Optic Enclosure with Adapter Bulkhead Positioned Beneath Pivotal Splice Tray” and filed on Jul. 16, 2009, which is hereby incorporated by reference in its entirety.

### BACKGROUND

Passive optical networks are becoming prevalent in part because service providers want to deliver high bandwidth communication capabilities to customers. Passive optical networks are a desirable choice for delivering high speed communication data because they may not employ active electronic devices, such as amplifiers and repeaters, between a central office and a subscriber termination. The absence of active electronic devices may decrease network complexity and/or cost and may increase network reliability.

FIG. 1 illustrates a network 100 deploying passive fiber optic lines. As shown in FIG. 1, the network 100 may include a central office 110 that connects a number of end subscribers 115 (also called end users 115 herein) in a network. The central office 110 may additionally connect to a larger network such as the Internet (not shown) and a public switched telephone network (PSTN). The network 100 may also include fiber distribution hubs (FDHs) 130 having one or more optical splitters (e.g., 1-to-8 splitters, 1-to-16 splitters, or 1-to-32 splitters) that generate a number of individual fibers that may lead to the premises of an end user 115. The various lines of the network can be aerial or housed within underground conduits (e.g., see conduit 105).

The portion of network 100 that is closest to central office 110 is generally referred to as the F1 region, where F1 is the “feeder fiber” from the central office. The F1 portion of the network may include a distribution cable having on the order of 12 to 48fibers; however, alternative implementations may include fewer or more fibers. The portion of network 100 that includes an FDH 130 and a number of end users 115 may be referred to as an F2 portion of network 100. Splitters used in an FDH 130 may accept a feeder cable having a number of fibers and may split those incoming fibers into, for example, 216 to 432 individual distribution fibers that may be associated with a like number of end user locations.

Referring to FIG. 1, the network 100 includes a plurality of break-out locations 125 at which branch cables are separated out from main cable lines. Breakout locations can also be referred to as tap locations, drop cable locations, splice locations or branch locations. Branch cables can also be referred to as drop cables, drop lines, breakout cables or stub cables. Branch cables are often connected to drop terminals 104 that include connector interfaces for facilitating coupling the fibers of the branch cables to a plurality of different subscriber locations. Breakout locations are often enclosed by a field mounted enclosure which protects optical splices (e.g., fusion or mechanical splices) or other types of optical couplings (e.g., connectorized optical couplings) provide at the breakout location. Since breakout locations are often provided at mid-span locations on the main cable being accessed, it desirable for field mounted enclosures to be readily mountable at mid-span access locations without requiring the main cable to be “threaded” lengthwise through the enclosure.

Fiber optic networks can extend to multi-dwelling units such as apartment buildings and condominiums. FIG. 2 shows a fiber optic network including a cable 150 routed into a multi-dwelling unit 152. Within the multi-dwelling unit 152, branch cables/fibers are optically coupled to the fibers of the cable 150 at optical coupling locations (e.g., fusion splices, mechanical splices or connectorized optical couplings). The optical coupling locations can be enclosed within one or more wall boxes that are typically equipped with doors/covers that can be opened to provide easy access to the optical coupling locations. The wall boxes are typically provided at different floors of the multi-dwelling unit with each wall box having optical coupling locations corresponding to a plurality of different subscribers (e.g., each resident on a given floor).

### SUMMARY

Certain aspects of the disclosure relate a wall box for use in a fiber optic network. The wall box can include structure that facilitates mounting the wall box at a mid-span access location of a fiber optic cable.

An aspect of the present disclosure relates to a fiber optic enclosure including an enclosure and a tray stack. The enclosure includes a base and a cover connected to the base. The base and the cover cooperate to define an interior region. The tray stack is disposed in the interior region of the enclosure. The tray stack includes a plurality of trays and a tray mounting plate. The tray mounting plate has a mounting portion and an adapter bulkhead portion. The mounting portion is adapted to receive the plurality of trays. The adapter bulkhead portion is adapted to receive a fiber optic adapter.

Another aspect of the present disclosure relates to a fiber optic enclosure. The fiber optic enclosure includes an enclosure and a tray stack. The enclosure includes a base and a cover connected to the base. The base and the cover cooperatively define an interior region. The tray stack is pivotally mounted within the interior region of the enclosure. The tray stack includes a tray mounting plate, a plurality of trays and at least one fiber optic adapter. The tray mounting plate has a mounting portion and an adapter portion. The adapter bulkhead portion is disposed on a side of the tray mounting plate that is opposite the mounting portion. The adapter bulkhead portion defines an adapter opening that extends through the adapter bulkhead portion. The plurality of trays is mounted to the mounting portion of the tray mounting plate. The at least one fiber optic adapter is disposed in the adapter opening of the adapter bulkhead portion of the tray mounting plate.

Another aspect of the present disclosure relates to a fiber optic enclosure. The fiber optic enclosure includes an enclosure and a tray stack. The enclosure includes a base and a cover connected to the base. The base and the cover cooperatively define an interior region. The tray stack is disposed within the interior region of the enclosure. The tray stack is adapted to pivot between a closed position and an open position. The tray stack includes a tray mounting plate, a plurality of trays and a plurality of fiber optic adapters. The tray mounting plate is hingedly engaged to the base of the enclosure. The tray mounting plate includes a mounting portion and an adapter portion. The adapter bulkhead portion is disposed on a side of the tray mounting plate that is opposite the mounting portion. The adapter bulkhead portion defines an adapter opening that extends a majority of a width of the adapter bulkhead portion. The plurality of trays is mounted to the mounting portion of the tray mounting plate. The plurality of fiber optic adapters is disposed in the adapter opening of the adapter bulkhead portion of the tray mounting plate.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a schematic representation of a prior art passive fiber optic network.

FIG. 2 is a schematic representation of a prior art passive fiber optic network.

FIG. 3 is a perspective view of a first end of an enclosure having exemplary features of aspects in accordance with the principles of the present disclosure.

FIG. 4 is a perspective view of a second end of the enclosure of FIG. 3.

FIG. 5 is an exploded perspective view of a fiber optic adapter suitable for use in the enclosure of FIG. 3.

FIG. 6 is a cross-sectional view of the fiber optic adapter of FIG. 5.

FIGS. 7 and 8 are perspective views of the enclosure of FIG. 3 shown in an open position.

FIGS. 9 and 10 are perspective views of the enclosure of FIG. 3 with a track stack shown in an open position.

FIG. 11 is a perspective view of a tray mounting plate suitable for use with the enclosure of FIG. 3.

FIG. 12 is a bottom view of the tray mounting plate of FIG. 11.

FIG. 13 is a side view of the tray mounting plate of FIG. 11.

FIG. 14 is a front view of the tray mounting plate of FIG. 11.

FIGS. 15 and 16 are perspective views of a tray stack suitable for use with the enclosure of FIG. 3.

FIGS. 17 and 18 are perspective view of the tray stack of FIGS. 15 and 16 shown in an open position.

FIG. 19 is a perspective view of an adapter suitable for use with the tray stack of FIGS. 15-18.

FIG. 20 is a cross-sectional view of the adapter taken on line 20-20 of FIG. 19.

FIG. 21 is a cable routing schematic suitable for use with the enclosure of FIG. 3.

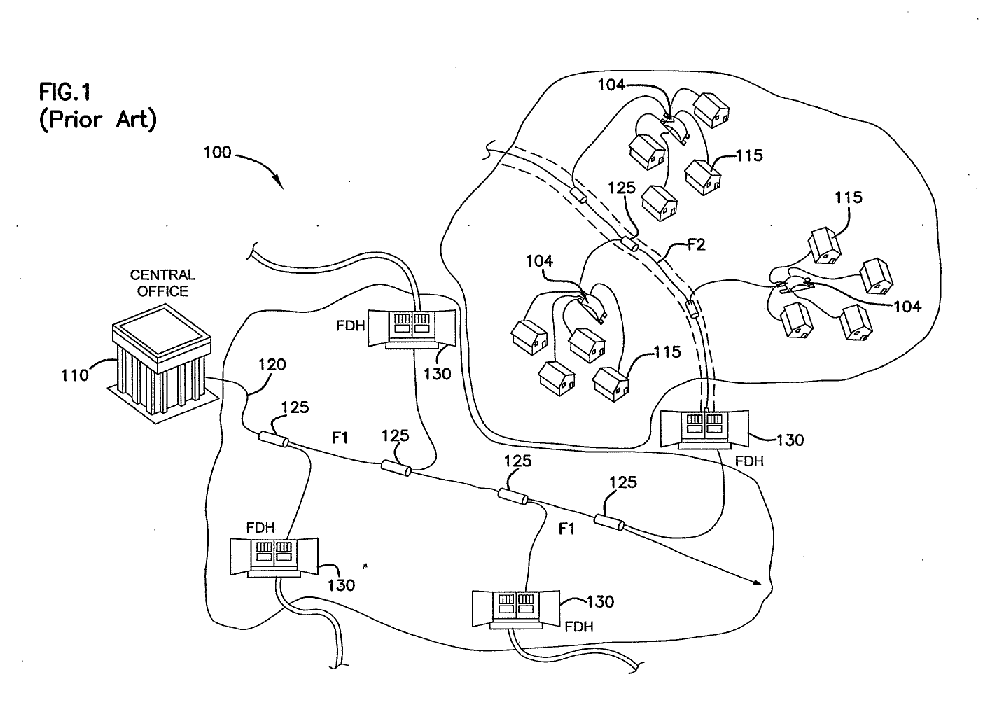

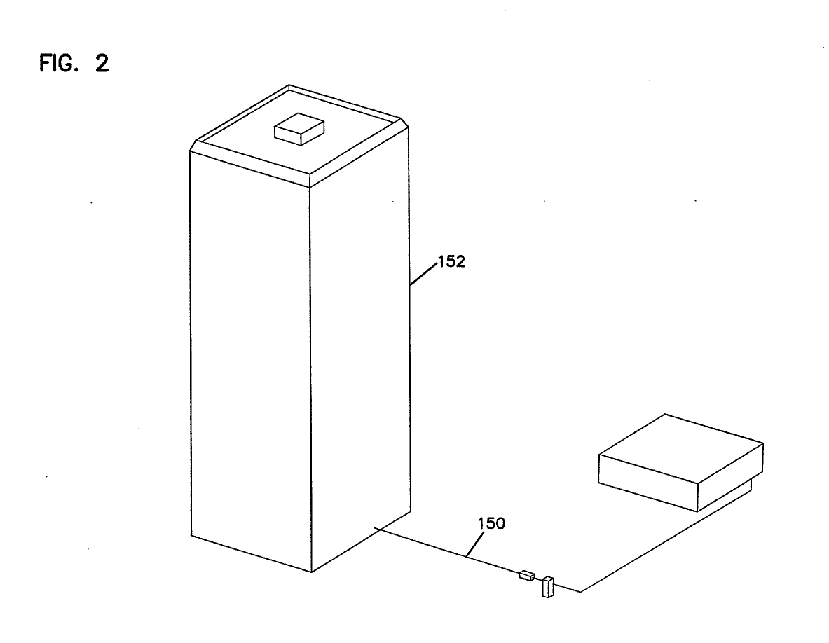

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

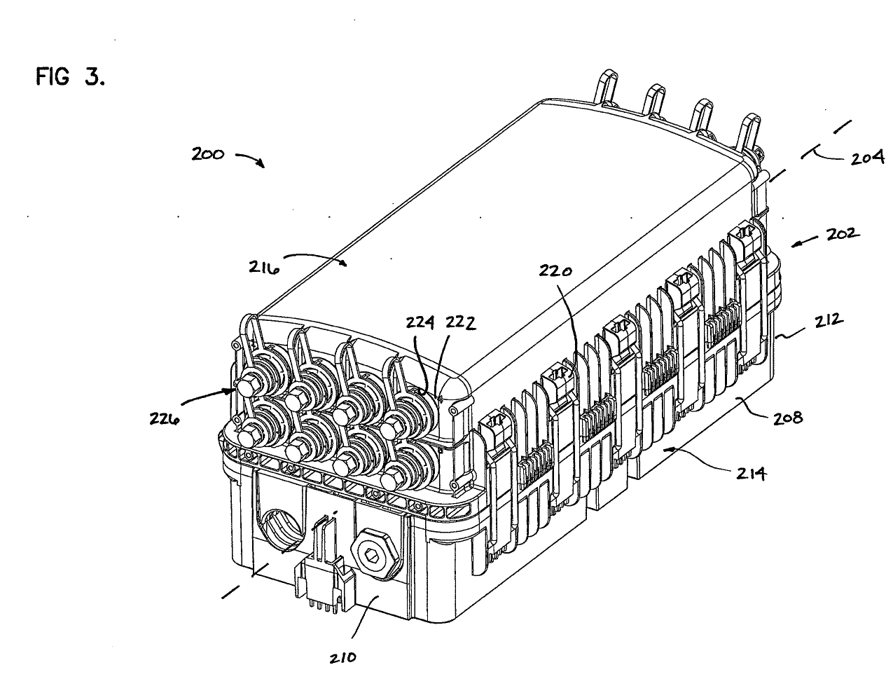

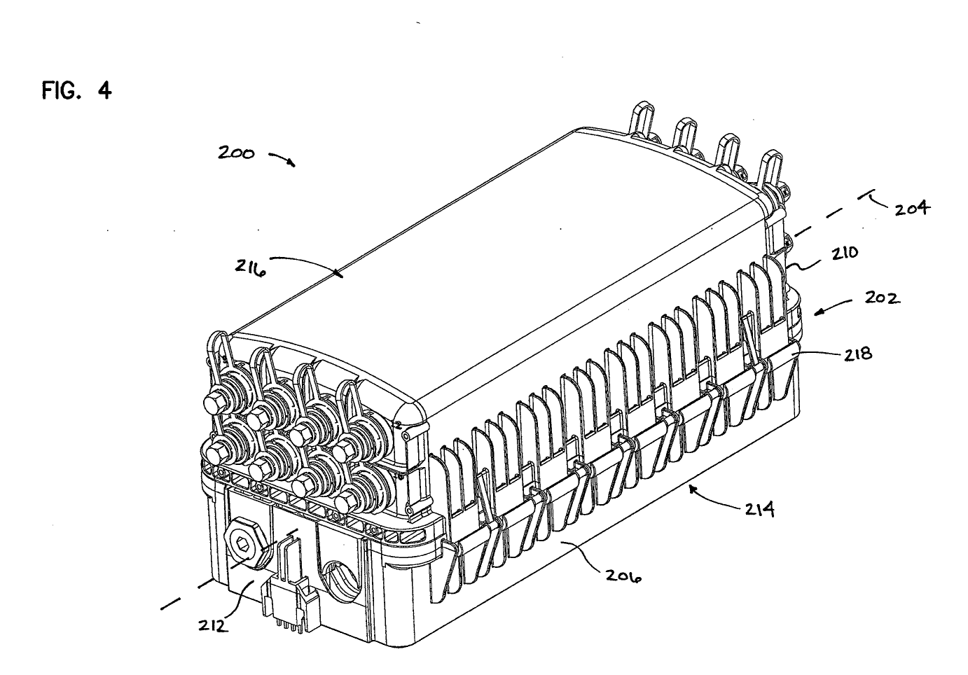

Referring now to FIGS. 3 and 4, an enclosure assembly, generally designated 200, is shown. The enclosure assembly 200 includes an enclosure 202. An enclosure suitable for use with the enclosure assembly 200 has been described in U.S. patent application Ser. No. 12/350,337, entitled “Wall Box Adapted to be Mounted at a Mid-Span Access Location of a Telecommunications Cable” and filed on Jan. 8, 2009, the disclosure of which is hereby incorporated by reference in its entirety.

In one aspect of the present disclosure, the enclosure 202 is generally rectangular in shape and defines a longitudinal axis 204 that extends through the center of the enclosure 202 in a longitudinal direction. The enclosure 202 includes a first side 206 and an oppositely disposed second side 208 where the first and second sides 206, 208 are generally parallel to the longitudinal axis 204. The enclosure 202 further includes a first end 210 and an oppositely disposed second end 212. The first and second ends 210, 212 are generally perpendicular to the longitudinal axis 204 and extend between the first and second sides 206, 208.

In one aspect of the present disclosure, the enclosure 202 includes a base 214 and a cover 216 mounted to the base 214. In the depicted example of FIG. 4, the cover 216 is pivotally mounted to the base 214 by hinges 218 disposed on the first side 206 of the enclosure 202. A plurality of latches 220 is disposed on the second side 208 of the enclosure 202. The plurality of latches 220 is adapted to secure the cover 216 in a closed position relative to the base 214.

The enclosure 202 includes at least one mounting portion 222. In one aspect of the present disclosure, the adapter mounting portion 222 is disposed on at least one of the first end 210 and the second end 212 of the enclosure 202. In another aspect of the present disclosure, each of the first and second ends 210, 212 of the enclosure 202 include the adapter mounting portion 222. In another aspect of the present disclosure, the adapter mounting portions 222 are disposed on the cover 216 of the enclosure.

The adapter mounting portion 222 includes a plurality of mounting openings 224. In one aspect of the present disclosure, each of the plurality of mounting openings 224 is adapted to receive a cable pass-thru fitting 225. Cable pass-thru fittings 225 suitable for use with the enclosure 202 have been described in U.S. Patent Application Ser. No. 61/155,099, entitled “Fiber Optic Cable Pass-Thru Fitting” and filed on Feb. 24, 2009, U.S. Patent Application Ser. No. 61/157,119, entitled “Fiber Optic Cable Pass-Thru Fitting” and filed on Mar. 3, 2009, U.S. Patent Application Ser. No. 61/158,212, entitled “Fiber Optic Cable Pass-Thru Fitting” and filed on Mar. 6, 2009, and U.S. Patent Application Ser. No. 61/167,106, entitled “Drop Cable Pass-Thru Fitting” and filed on Apr. 6, 2009, the disclosures of which are hereby incorporated by reference in their entirety.

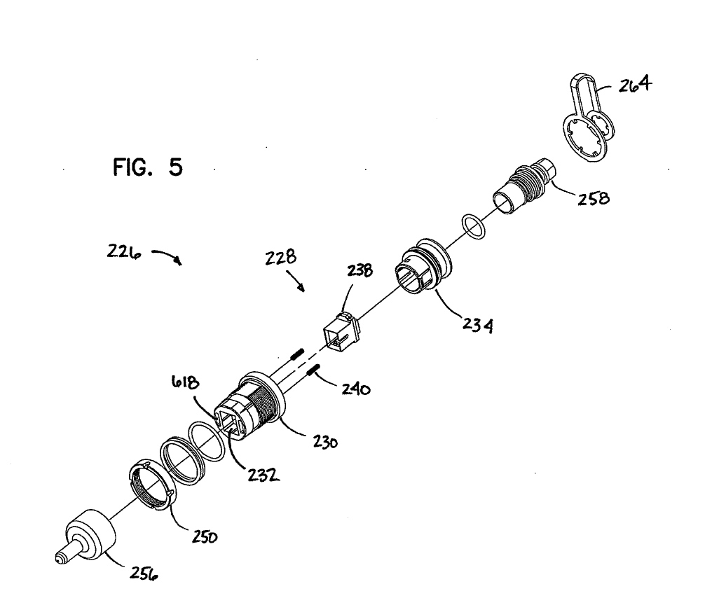

Referring now to FIGS. 3, 5 and 6, in another aspect of the present disclosure, each of the plurality of mounting openings 224 is adapted to receive a ruggedized fiber optic adapter 226. The fiber optic adapter 226 includes a main housing 228 having a first piece 230 that defines an inner port 232 of the fiber optic adapter 226 and a second piece 234 that defines an outer port 236 of the fiber optic adapter 226. The first and second pieces 230, 234 can be interconnected by a snap-fit connection to form the main housing 228. A split sleeve housing 238 mounts within the interior of the main housing 228. Springs 240 bias the split sleeve housing 238 toward the outer port 236 and allow the split sleeve housing 238 to float within the interior of the main housing 228. As shown in FIG. 5, the split sleeve housing 238 houses a standard split sleeve 242 that is coaxially aligned with a center axis 244 of the fiber optic adapter 226. The split sleeve 242 includes a first end 246 that faces toward the inner port 232 of the fiber optic adapter 226 and a second end 248 that faces toward the outer port 236 of the fiber optic adapter 226.

The fiber optic adapter 226 mounts within one of the adapter mounting openings 224 defined by the enclosure 202. The fiber optic adapter 226 is retained within the adapter mounting opening 224 by a retention nut 250 threaded on exterior threads defined by the first piece 230 of the main housing 228. When the retention nut 250 is threaded into place, the corresponding adapter mounting portion 222 is captured between the retention nut 250 and a shoulder 252 of the main housing 228. A sealing member 254 is compressed between the main housing 228 and the adapter mounting portion 222 to provide an environmental seal about the adapter mounting opening 224.

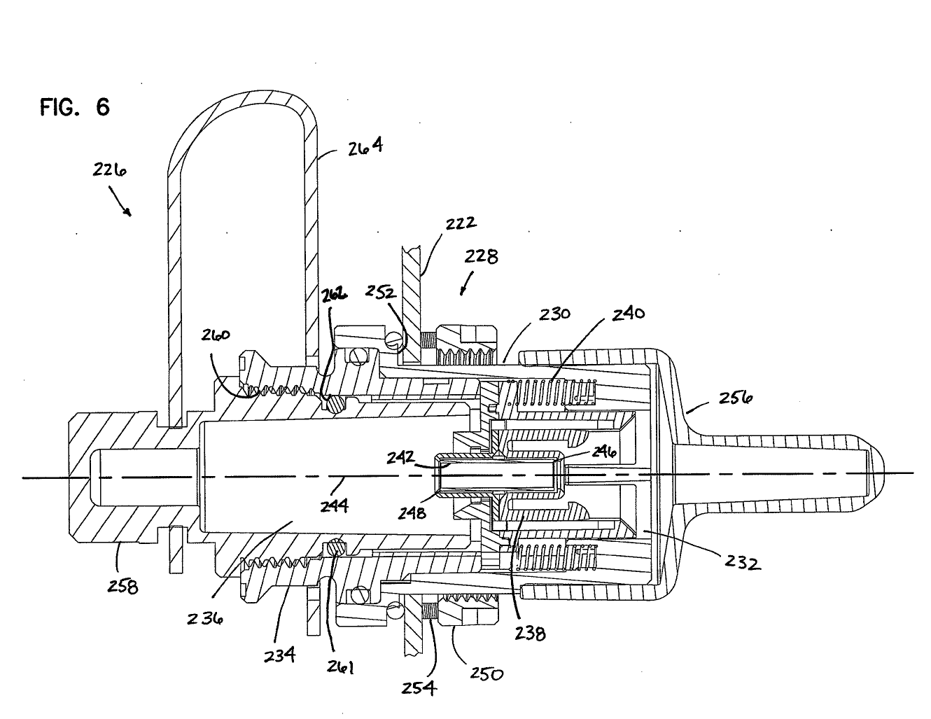

As shown in FIG. 6, a dust cap 256 is shown mounted covering the inner port 232 of the fiber optic adapter 226 and a plug 258 is shown mounted within the outer port 236 of the fiber optic adapter 226. The plug 258 is threaded within internal threads 260 defined within the outer port 236. The plug 258 also includes a sealing member 261 (e.g., an O-ring) that engages a sealing surface 262 within the outer port 236 to provide an environmental seal between the main housing 228 and the plug 258. A strap 264 secures the plug 258 to the main housing 228 to prevent the plug 258 from being misplaced when removed from the outer port 236.

Referring now to FIGS. 7-10, the enclosure 202 is shown in an open position. The base 214 of the enclosure 202 defines a first cavity 266a while and the cover 216 of the enclosure 202 defines a second cavity 266b. The first and second cavities 266a, 266b form an interior region 266 of the enclosure 202 when the enclosure 202 is in the closed position. With the enclosure 202 in the open position, the first cavity 266a is accessible through a first opening 268a cooperatively defined by the first and second sides 206, 208 and the first and second ends 210, 212 of the base 214 while the second cavity 266b is accessible through a second opening 268b cooperatively defined by the first and second sides 206, 208 and the first and second ends 210, 212 of the cover 216.

The enclosure 202 defines a plurality of cable openings 270 for allowing a telecommunications cable to be routed through the enclosure 202. In one aspect of the present disclosure, the base 214 defines the plurality of cable openings 270. In one aspect of the present disclosure, the enclosure 202 defines two cable openings 270 on the first end 210 of the enclosure 202 and two cable openings 270 on the second end 212 of the enclosure 202.

Each of the cable openings 270 defines a central axis 272 that extends through the center of the cable opening 270 between the first and second ends 210, 212 of the enclosure 202. The central axes 272 of the cable openings 270 defined by the first end 210 of the enclosure 202 are axially aligned with the central axes 272 of the cable openings defined by the second end 212. The alignment of the cable openings 270 provides first and second cable pass-thru paths that extend through the enclosure 202.

The enclosure assembly 200 includes a tray stack 300 disposed in the interior region 266 of the enclosure 202. The tray stack 300 provides a mid-span access location in the enclosure 202 at which optical fibers of the fiber optic cable that is routed through the enclosure 202 can be terminated and/or split. The tray stack 300 includes a tray mounting plate 302 and a plurality of trays 304.

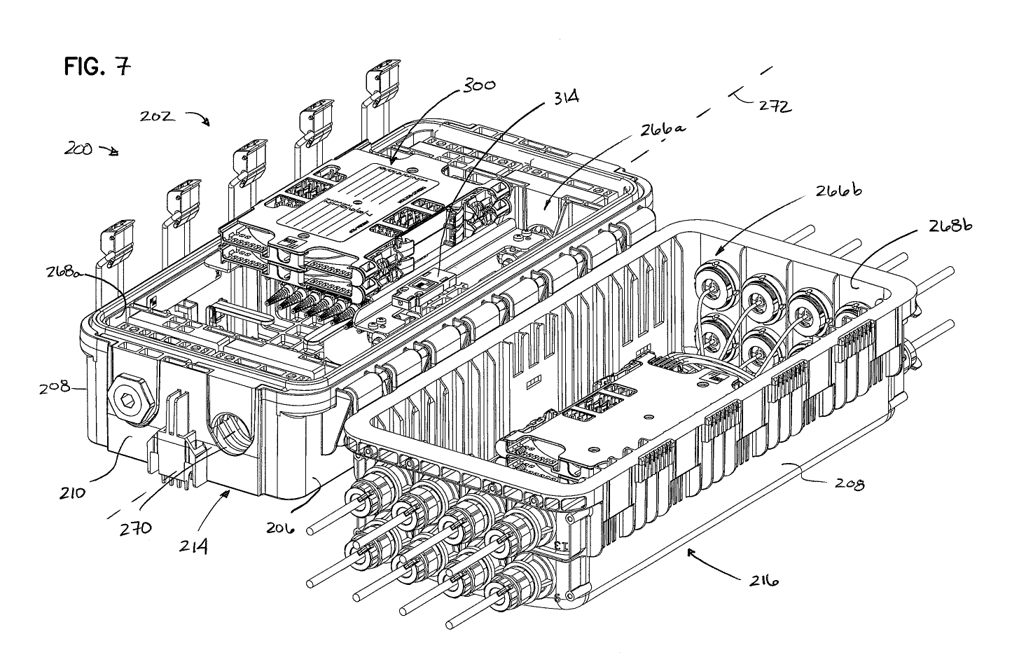

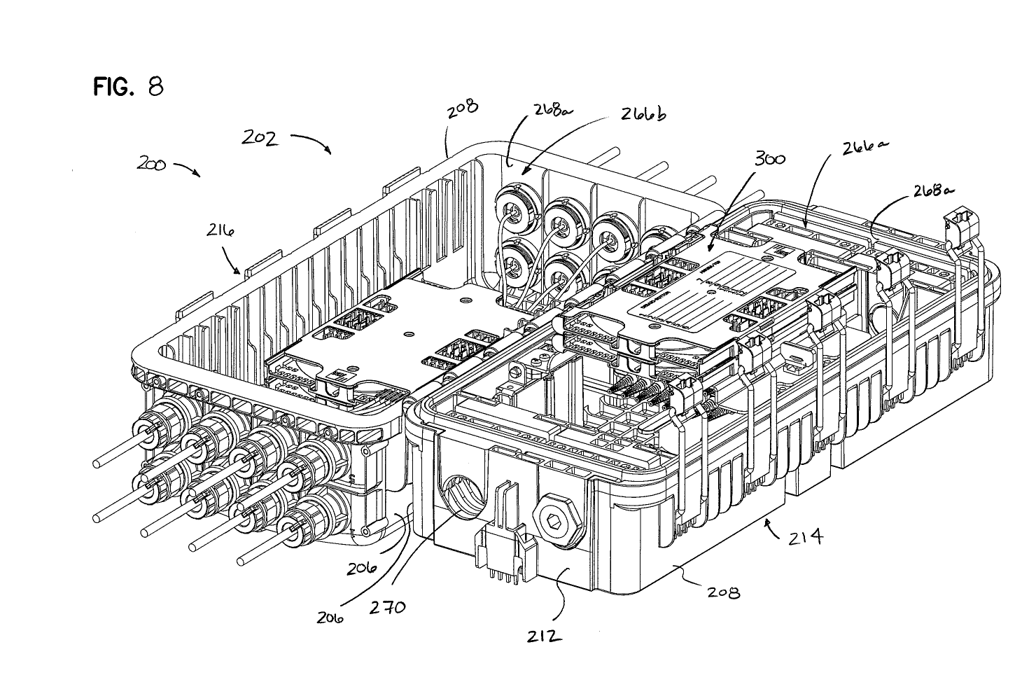

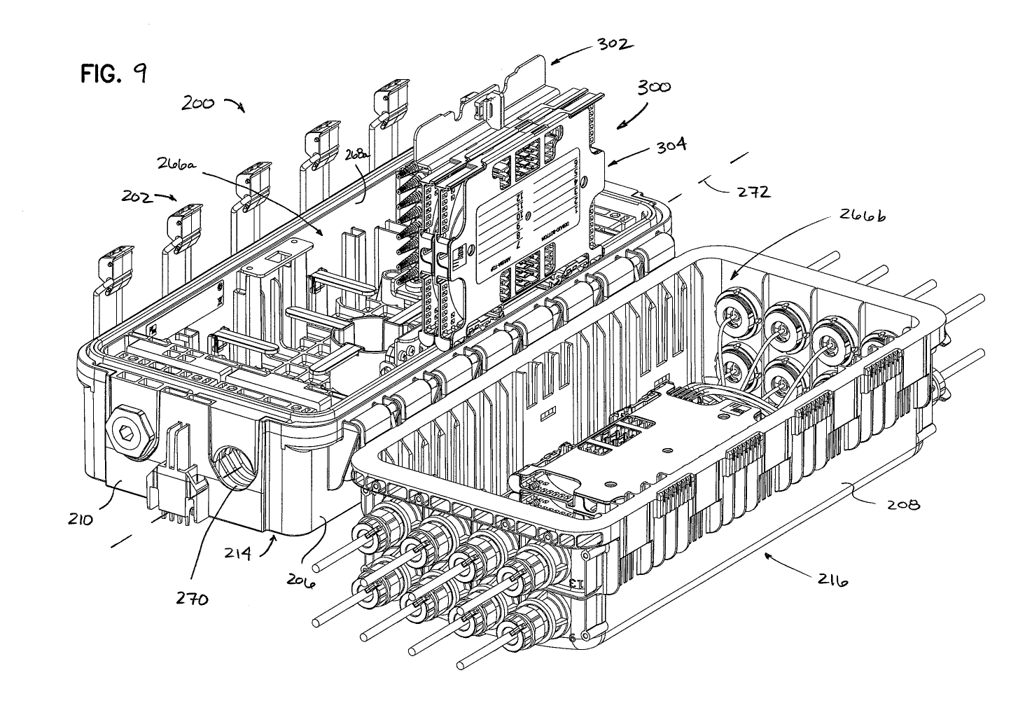

In order to facilitate access to the fiber optic cable and/or the optical fibers routed through the enclosure 202, the tray stack 300 selectively pivots relative to the enclosure 202. In one aspect of the present disclosure, the tray stack 300 selectively pivots between a closed position (shown in FIGS. 7 and 8) and an open position (shown in FIGS. 9 and 10). In one aspect of the present disclosure, the open position of the tray stack 300 is about 90 degrees from the closed position. In one aspect of the present disclosure, the tray stack 300 is held in the open position by a detent.

The tray mounting plate 302 of the tray stack 300 is pivotally engaged with the enclosure 202. In one aspect of the present disclosure, the tray mounting plate 302 is pivotally engaged with the first side 206 of the enclosure 202. In another aspect of the present disclosure, the tray mounting plate 302 is pivotally engaged with the first side 206 of the base 214 of the enclosure 202.

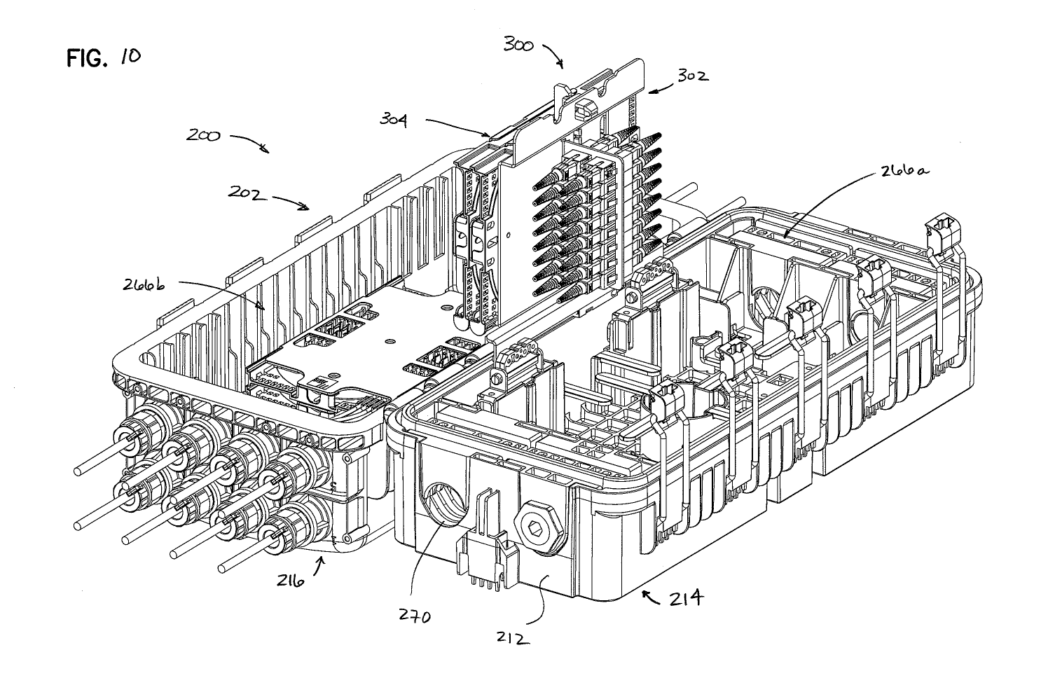

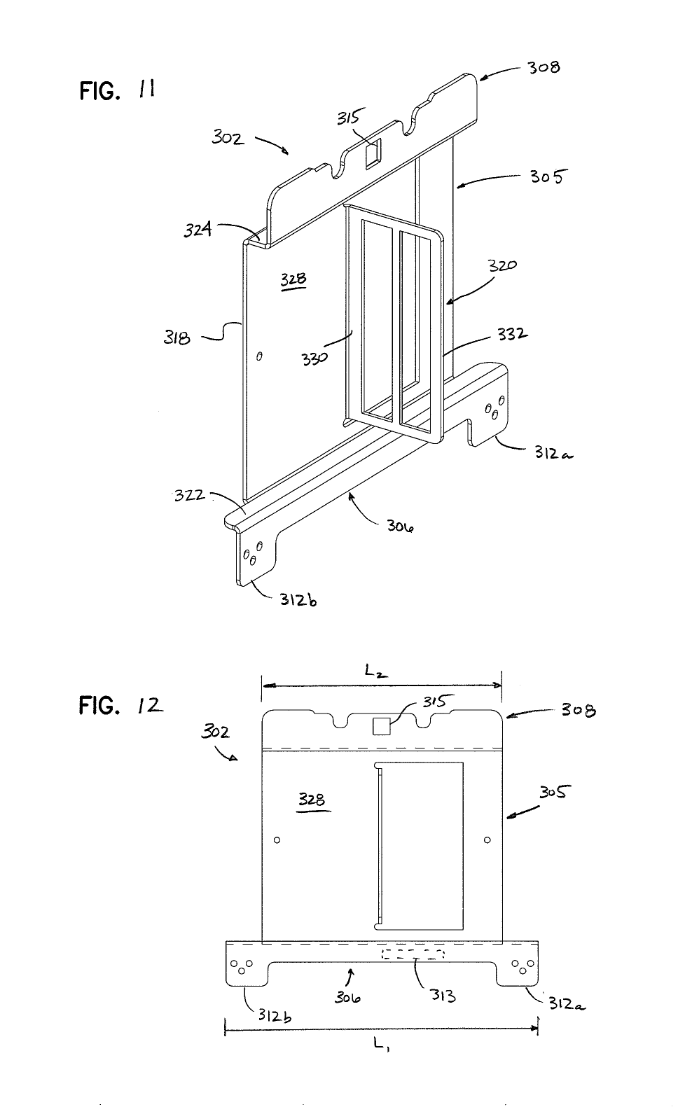

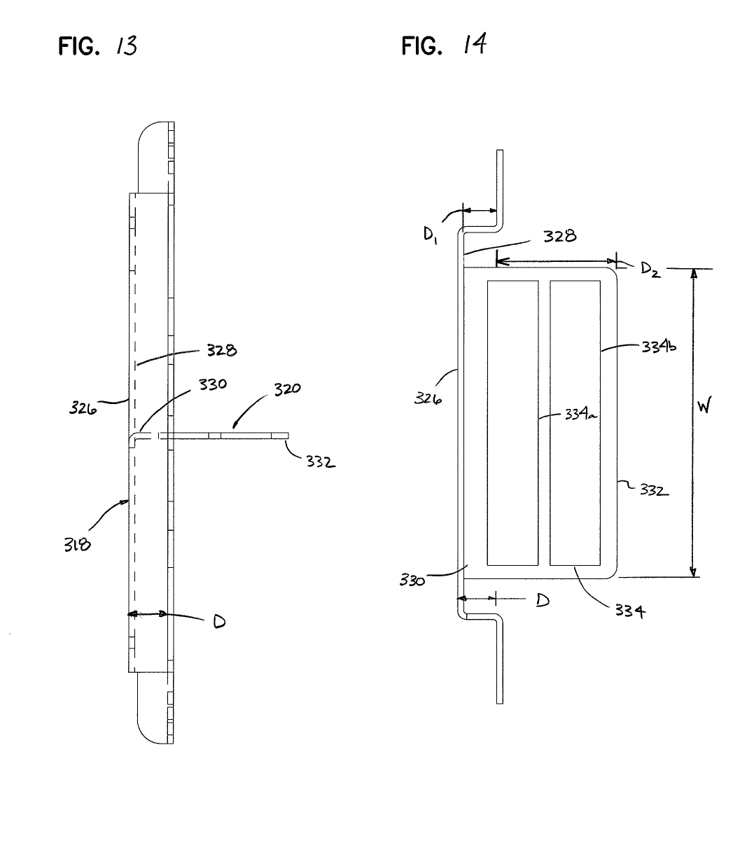

Referring now to FIGS. 11-14, the tray mounting plate 302 is shown. The tray mounting plate 302 includes a main body 305 having a first side portion 306 and an oppositely disposed second side portion 308. In one aspect of the present disclosure, the first and second side portions 306, 308 are generally planar.

The first side portion 306 of the tray mounting plate 302 has a first longitudinal length L₁. The first side portion 306 serves as a location at which the tray mounting plate 302 can be mounted to the enclosure 202.

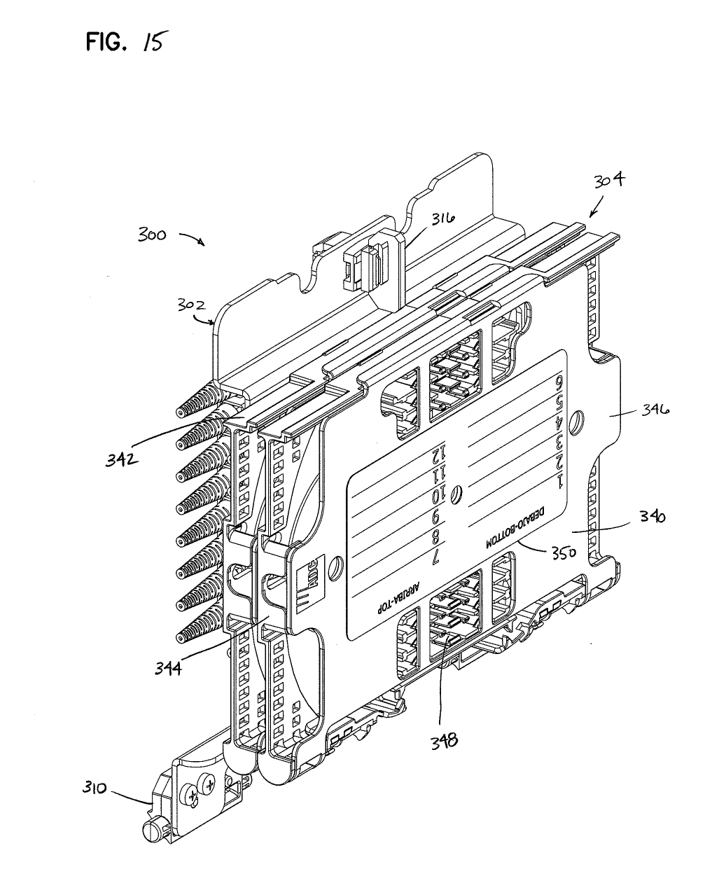

In one aspect of the present disclosure, the first side portion 306 is adapted for engagement with a plurality of hinges 310 (best shown in FIGS. 15-18). Each of the plurality of hinges 310 is engaged with the enclosure 202 to allow the tray mounting plate 302 to pivot relative to the enclosure 202. A first hinge 310a is engaged with a first end portion 312a of the first side portion 306 at while a second hinge 310b is engaged with an oppositely disposed second end portion 312b.

In one aspect of the present disclosure, the first side portion 306 of the tray mounting plate 302 includes a fan-out mounting area 313. The fan-out mounting area 313 is adapted to receive a fan-out 314 (shown in FIG. 7). In one aspect of the present disclosure, the fan-out 314 is mounted to the fan-out mounting area 313 with a fastener (e.g., a clip, screws, adhesive, cable tie, etc.).

In one aspect of the present disclosure, the second side portion 308 is generally aligned with the first side portion 306. The second side portion 308 has a second longitudinal length L₂. In one aspect of the present disclosure, the second longitudinal length L₂ is less than or equal to the first longitudinal length L₁. In another aspect of the present disclosure, the second longitudinal length L₂ is less than the first longitudinal length L₁. In another aspect of the present disclosure, the second longitudinal length L₂ is less than or equal to about 80% of the first longitudinal length L₁.

The second side portion 308 defines a latch opening 315 that extends through the second side portion 308. In one aspect of the present disclosure, the latch opening 315 is generally square-shaped. In one aspect of the present disclosure, the latch opening 315 is disposed generally midway along the second longitudinal length L₂ of the second side portion 308. The latch opening 315 is adapted to receive a latch 316 (best shown in FIGS. 15-18). The latch 316 is adapted to secure the tray stack 300 in the closed position.

The tray mounting plate 302 further includes a mounting portion 318 and an adapter bulkhead portion 320. Each of the mounting portion 318 and the adapter bulkhead portion 320 is disposed between the first and second side portions 306, 308.

The mounting portion 318 is adapted to receive the plurality of trays 304. In one aspect of the present disclosure, the mounting portion 318 is generally offset from the first and second side portions 306, 308 by an offset distance D. In one aspect of the present disclosure, the mounting portion 318 is generally parallel to the first and second side portions 306, 308.

A first sidewall 322 extends between the first side portion 306 and the mounting portion 318 while a second sidewall 324 extends between the second side portion 308 and the mounting portion 318. In one aspect of the present disclosure, the first side portion 306, the first sidewall 322, the mounting portion 318, the second sidewall 324 and the second side portion 308 are integral. In another aspect of the present disclosure, the first side portion 306, the first sidewall 322, the mounting portion 318, the second sidewall 324 and the second side portion 308 are monolithic.

The mounting portion 318 includes a first surface 326 and an oppositely disposed second surface 328. The first surface 326 is generally planar in shape and is adapted to receive the plurality of trays 304. In one aspect of the present disclosure, one of the trays 304 is directly mounted to the first surface 326 of the mounting portion 318.

The adapter bulkhead portion 320 is disposed on a side of the tray mounting plate 302 that is opposite from the side on which the plurality of trays 304 is mounted. In one aspect of the present disclosure, the adapter bulkhead portion 320 is disposed beneath the plurality of trays 304 of the tray stack 300.

The adapter bulkhead portion 320 includes a base end 330 and an oppositely disposed free end 332. The base end 330 is engaged to the mounting portion 318 while the free end 332 extends in an outward direction from the second surface 328.

The first and second side portions 306, 308 are generally positioned at a location between the base end 330 and the free end 332 of the adapter bulkhead portion 320. The first and second side portions 306, 308 are disposed at a first longitudinal distance D₁ from the base end 330 of the adapter bulkhead portion 320 and a second longitudinal distance D₂ from the free end 332 of the adapter bulkhead portion 320. In one aspect of the present disclosure, the second longitudinal distance D₂ is greater than the first longitudinal distance D₁. In another aspect of the present disclosure, the first longitudinal distance D₁ is greater than or equal to about 10% of the second longitudinal distance D₂. In another aspect of the present disclosure, the first longitudinal distance D₁ is greater than or equal to about 20% of the second longitudinal distance.

In the depicted embodiments of the figures, the adapter bulkhead portion 320 is generally perpendicular to the mounting portion 318. In another aspect of the present disclosure, the adapter bulkhead portion 320 is generally perpendicular to the first and second side portions 306, 308.

In one aspect of the present disclosure, the adapter bulkhead portion 320 is integral with the mounting portion 318. In another aspect of the present disclosure, the adapter bulkhead portion 320 and the mounting portion 318 are monolithic.

The adapter bulkhead portion 320 includes an adapter opening 334 that extends through the adapter bulkhead portion 320. In one aspect of the present disclosure, the adapter opening 334 is adapted to receive at least one fiber optic adapter 336. In the depicted embodiment of FIGS. 11 and 14, the adapter opening 334 is adapted to receive a plurality of adapters 336 (shown in FIGS. 10, 16 and 18-20). In one aspect of the present disclosure, the adapter bulkhead portion 320 includes a first adapter opening 334a and a second adapter opening 334b. In one aspect of the present disclosure, each of the first and second adapter openings 334a, 334b extend a majority of a width W of the adapter bulkhead portion 320.

The tray mounting plate 302 is pivotally mounted to the base 214 of the enclosure 202. In one aspect of the present disclosure, the hinges 310 that are engaged with the first side portion 306 of the tray mounting plate 302 are also engaged with the first side 206 of the base 214 at a location that is adjacent to the first opening 268a of the first cavity 266a of the base 214. The tray mounting plate 302 is mounted to the base 214 such that the mounting portion 318 of the tray mounting plate 302 and the plurality of trays 304 mounted to the mounting portion 318 are disposed outside of the first cavity 266a of the base 214 when the enclosure 202 is in the open position while a majority of the adapter bulkhead portion 320 is disposed in the first cavity 266a of the base 214. When the enclosure 202 is in the closed position, the mounting portion 318 of the tray mounting plate 302 and the plurality of trays 304 are disposed in the second cavity 266b of the cover 216 while a majority of the adapter bulkhead portion 320 is disposed in the first cavity 266a of the base 214.

Referring now to FIGS. 15-18, the tray stack 300 is shown. The tray stack 300 includes the plurality of trays 304 mounted to the mounting portion 318 of the tray mounting plate 302 and at least one fiber optic adapter 336 mounted to the adapter bulkhead portion 320.

In one aspect of the present disclosure, the plurality of trays 304 includes at least one splice tray 340 and at least one splitter tray 342. Trays suitable for use with the enclosure 202 have been described in U.S. patent application Ser. No. 12/370,040, entitled “Fiber Optic Splice Enclosure” and filed on Feb. 12, 2009, and in U.S. patent application Ser. No. 12/425,241 entitled “Fiber Optic Splice Tray” and filed on Apr. 16, 2009, the disclosures of which are hereby incorporated by reference in their entirety.

Each of the plurality of trays 304 includes a base piece 344 and a cover piece 346. In one aspect of the present disclosure, the cover piece 346 is pivotally engaged to the base piece 344. The base piece 344 of the splice tray 340 includes a splice mounting location 348 and a fiber storage region. The cover piece 346 of the splice tray 340 includes a cable identification area 350. The cable identification area 350 provides a location for storing information about the optical fibers routed in the trays 304.

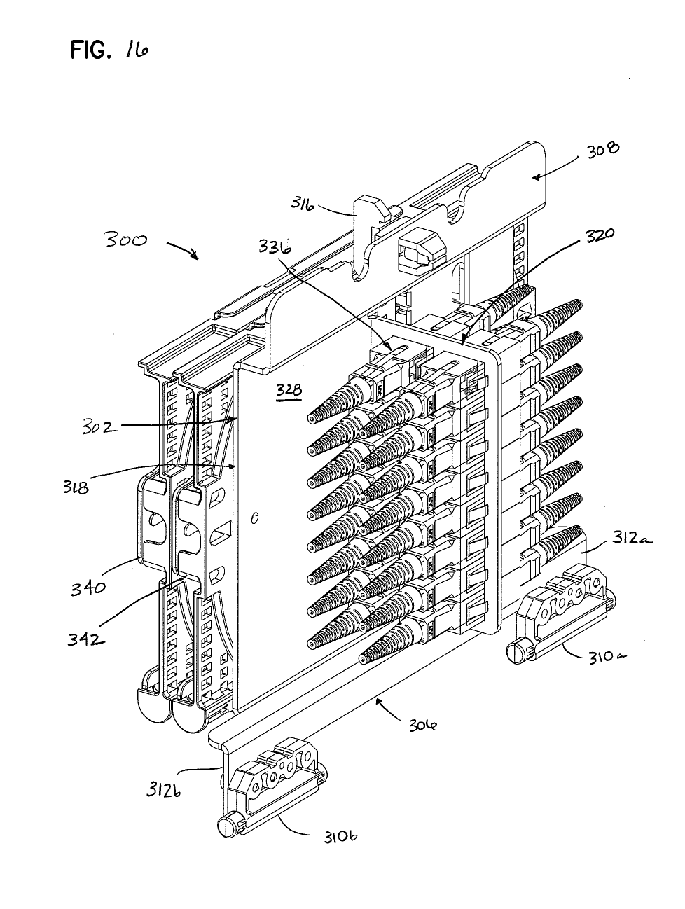

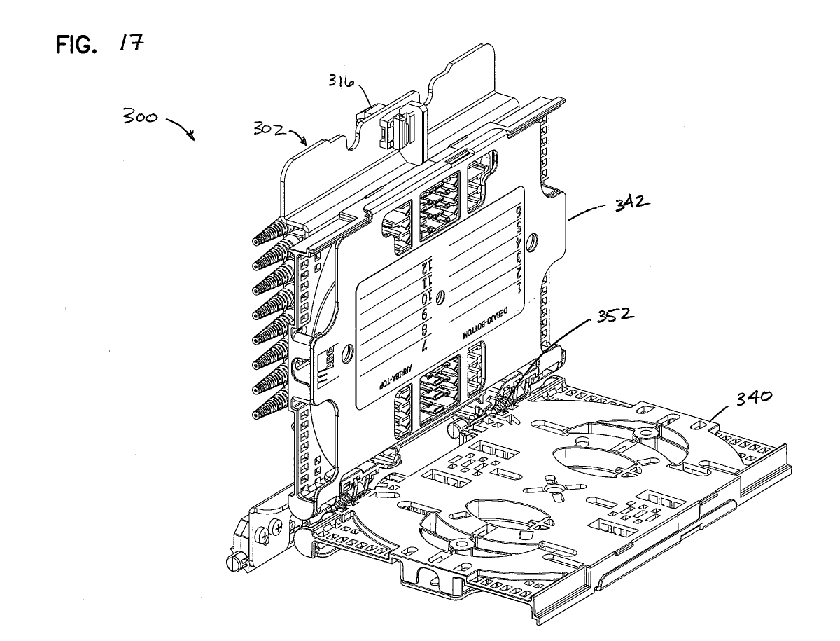

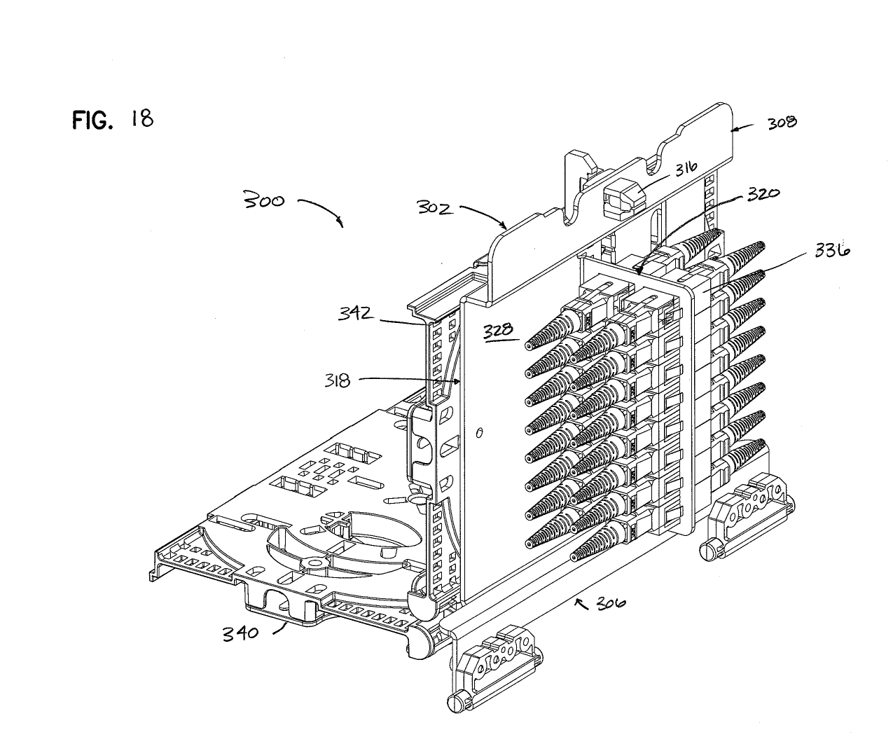

In one aspect of the present disclosure, each of the plurality of trays 304 is pivotally engaged to an adjacent tray 304 by a plurality of hinges 352. The trays 304 pivot between a closed position (shown in FIGS. 15 and 16) and an open position (shown in FIGS. 17 and 18).

In the depicted embodiment of FIGS. 15-18, the tray stack 300 includes a plurality of adapters 336 mounted to the adapter bulkhead portion 320 of the tray mounting plate 302. In one aspect of the present disclosure, each of the plurality of adapters 336 is similar.

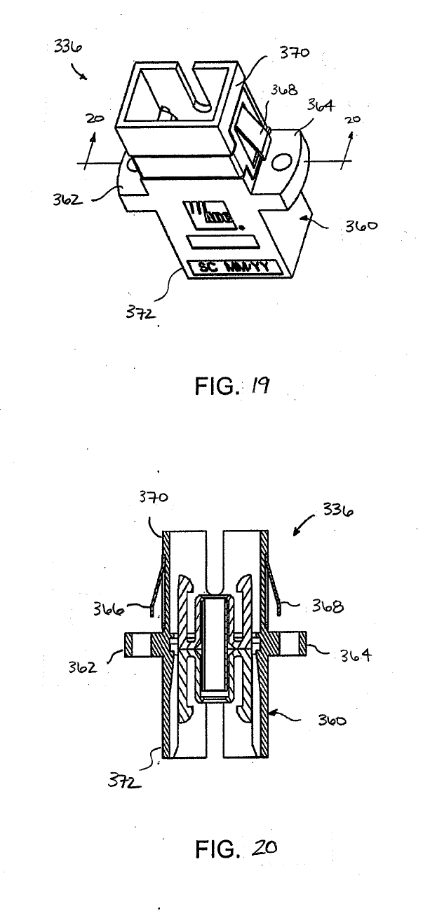

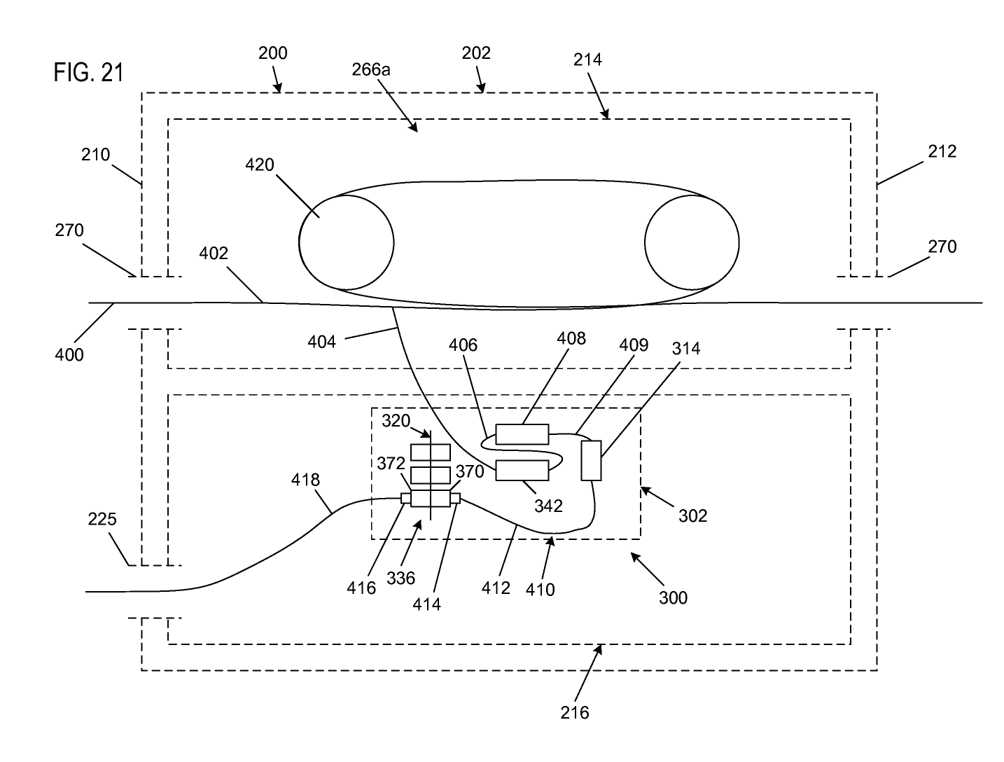

Referring now to FIGS. 19 and 20, an exemplary adapter suitable for use with the enclosure 202 is shown. In the depicted embodiment of FIGS. 19 and 20, the adapter 336 is an SC-type adapter. As the SC-type adapter was described in U.S. Pat. No. 5,317,663, which is hereby incorporated by reference in its entirety, the SC-type adapter will only be briefly described herein. The SC-type adapter includes a main body 360 with a pair of tabs 362, 364 located on the exterior of the main body 360. The tabs 362, 364 serve to support the adapter 3336 in the adapter bulkhead portion 320 of the tray mounting plate 302. The adapter 336 further includes a pair of retaining clips 366, 368, with one retaining clip 366, 368 associated with each tab 362, 364.

The adapter 336 includes a first side 370 and a second side 372. The first and second sides 370, 372 are adapted to receive single fiber connectors. The first side 370 of the adapter 336 is inserted into the adapter opening 334 of the adapter bulkhead portion 320. As the adapter 336 is inserted through an adapter opening 334, the retaining clips 366, 368 compress against the main body 360. The adapter 336 is inserted into the adapter bulkhead portion 320 until the tabs 362, 364 abut the adapter bulkhead portion 320. With the tabs 362, 364 abutting the adapter bulkhead portion 320, the retaining clips 366, 368 decompress on the opposite side of the adapter bulkhead portion 320, thereby retaining the adapter bulkhead portion 320 between the retaining clips 366, 368 and the tabs 362, 364.

Referring now to FIGS. 7-21, the routing of the fiber optic cable 400 through the enclosure 202 will be described. A mid-span location 402 along a fiber optic cable 400 is identified. At that mid-span location 402, a portion of an outer jacket of the fiber optic cable 400 is removed. In one aspect of the present disclosure, the portion of the outer jacket of the fiber optic cable 400 that is removed is in the range of about 0.5 feet to about 3 feet.

With the enclosure 202 in the open position, the fiber optic cable 400 at the mid-span location 402 is inserted into one of the plurality of cable openings 270 defined by the first end 210 of the base 214 and one of the plurality of cable openings 270 defined by the second end 212 of the base 214. With the fiber optic cable inserted into the cable openings 270, the portion of fiber optic cable 400 having its outer jacket removed is disposed in the first cavity 266a of the base 214.

A first optical fiber 404 of the fiber optic cable 400, which is disposed in the first cavity 266a of the base 214, is cut and routed to one of the plurality of trays 304 of the tray stack 300. In one aspect of the present disclosure, the optical fiber 404 is routed to the splice tray 342. In the splice tray 342, the optical fiber 404 is optically connected to an input fiber 406 of a splitter 408. The splitter 408 is disposed on the splitter tray 340.

An upjacketed output fiber 409 is routed from the splitter 408 to the fan-out 314. In one aspect of the present disclosure, the upjacketed fiber has an outer diameter of about 2 millimeters. The fan-out 314 serves as a transition location between the upjacketed fiber 408 and a ribbon cable 410 having multiple optical fibers 412. Each of the optical fibers 412 of the ribbon cable 410 has a connectorized end 414. Each of the connectorized ends 414 of the ribbon cable 410 is engaged with one of the first sides 370 of the plurality of adapters 336 mounted to the adapter bulkhead portion 320 of the tray mounting plate 302 of the tray stack 300.

A connectorized end 416 of a drop cable 418 is engaged to the second end 372 of the adapter 336 in the adapter bulkhead portion 320 of the tray stack 300. The drop cable 418 exits the enclosure through a cable pass-thru fitting 225 disposed on the cover 216 of the enclosure 202.

Any excess fiber optic cable 400 disposed in the first cavity 266a of the base 214 is wrapped around cable management spools 420 disposed in the base 214. With the excess fiber optic cable 400 coiled around the cable management spool 420, the fiber optic cable 420 exits the enclosure 202 through the cable opening 270 disposed on the second end 212 of the base 214.

The cover 216 is then engaged to the base 214. In one aspect of the present disclosure, the cover 216 is sealing engaged to the base 214.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A fiber optic enclosure comprising:
an enclosure having:
a base;
a cover connected to the base, wherein the base and the cover cooperate to define an interior region;
a tray stack disposed within the interior region of the enclosure, the tray stack including:
a plurality of trays; and
a tray mounting plate having a mounting portion and an adapter bulkhead portion, the mounting portion being adapted to receive the plurality of trays, the adapter bulkhead portion being adapted to receive a fiber optic adapter.

2. The fiber optic enclosure of claim 1, wherein the tray stack pivots relative to the enclosure between an open position and a closed position.

3. The fiber optic enclosure of claim 1, wherein the tray mounting plate of the tray stack is pivotally engaged to the enclosure.

4. The fiber optic enclosure of claim 3, wherein a hinge is engaged to the tray mounting plate and the enclosure to allow the tray mounting plate to pivot relative to the enclosure.

5. The fiber optic enclosure of claim 1, wherein the plurality of trays includes a splice tray and a splitter tray.

6. The fiber optic enclosure of claim 1, wherein the adapter bulkhead portion of the tray mounting plate is disposed on a side of the tray mounting plate that is opposite from a side on which the plurality of trays is mounted.

7. The fiber optic enclosure of claim 1, wherein the adapter bulkhead portion includes a base end and an oppositely disposed free end.

8. A fiber optic enclosure comprising:
an enclosure having:
a base;
a cover connected to the base, wherein the base and the cover cooperate to define an interior region;
a tray stack pivotally mounted within the interior region of the enclosure, the tray stack including:
a tray mounting plate having a mounting portion and an adapter portion, the adapter bulkhead portion being disposed on a side of the tray mounting plate that is opposite from the mounting portion, the adapter bulkhead portion defines an adapter opening that extends through the adapter bulkhead portion;
a plurality of trays mounted to the mounting portion of the tray mounting plate; and
at least one fiber optic adapter disposed in the adapter opening of the adapter bulkhead portion of the tray mounting plate.

9. The fiber optic enclosure as claimed in claim 8, wherein a hinge is engaged to the tray mounting plate and the enclosure to allow the tray mounting plate to pivot relative to the enclosure.

10. The fiber optic enclosure of claim 8, wherein the plurality of trays includes a splice tray and a splitter tray.

11. The fiber optic enclosure of claim 8, wherein the adapter bulkhead portion includes a first adapter opening and a second adapter opening, each of the first and second adapter openings extending a majority of a width of the adapter bulkhead portion.

12. The fiber optic enclosure of claim 11, wherein a plurality of adapters is disposed in the first and second adapter openings.

13. The fiber optic enclosure of claim 8, wherein each of the plurality of trays is pivotally engaged to an adjacent tray.

14. The fiber optic enclosure of claim 8, wherein the tray mounting plate includes a fan-out mounting area.

15. The fiber optic enclosure of claim 8, wherein the tray mounting plate is held in an open position by a detent.

16. The fiber optic enclosure of claim 15, wherein a latch secures the tray mounting plate in a closed position.

17. A fiber optic enclosure comprising:
an enclosure having:
a base;
a cover connected to the base, wherein the base and the cover cooperate to define an interior region;
a tray stack disposed within the interior region of the enclosure, the tray stack being adapted to pivot between a closed position and an open position, the tray stack including:
a tray mounting plate hingedly engaged to the base of the enclosure, the tray mounting plate including:
a mounting portion;
an adapter portion disposed on a side of the tray mounting plate that is opposite the from the mounting portion, the adapter bulkhead portion defining an adapter opening that extends a majority of a width of the adapter bulkhead portion;
a plurality of trays mounted to the mounting portion of the tray mounting plate; and
a plurality of fiber optic adapters disposed in the adapter opening of the adapter bulkhead portion of the tray mounting plate.

18. The fiber optic enclosure of claim 17, wherein the tray stack is held in the open position by a detent.

19. The fiber optic enclosure of claim 18, wherein a latch secures the tray stack in the closed position.

20. The fiber optic enclosure of claim 19, wherein the tray mounting plate defines a latch opening that receives the latch in the closed position.
